(19) United States
(12) Patent Application Publication
(10) Pub. No.: US 2018/0328097 A1
(43) Pub. Date: Nov. 15, 2018

(54) ELECTRICAL POWER ASSISTED MANUALLY OPERATED DOOR

(71) Applicant: Multimatic, Inc., Markham (CA)

(72) Inventors: Laurence J HOLT, Goodwood (CA); Paul R WHITE, Norfolk (GB)

(21) Appl. No.: 15/775,163

(22) PCT Filed: Nov. 11, 2016
(86) PCT No.: PCT/US2016/061611

§ 371 Date: May 10, 2018

Related U.S. Application Data
(60) Provisional application No. 62/255,229, filed on Nov. 13, 2015.

(51) Int. Cl. E05F 15/70; E05F 15/616; B60J 5/04

(52) U.S. Cl. CPC E05F 15/70; E05Y 2900/531; B60J 5/04; E05F 15/616

(57) ABSTRACT

A power assisted automotive door system has a power drive module which includes an electric motor and integrated gearbox drive unit that provides a driving torque around the door's pivot axis. A controller is in communication with the electric motor, a torque sensor, a velocity sensor, and an accelerometer and processes measured and provided data and to predict a door torque using a real-time simulation. The controller commands the power drive module to produce a compensating torque that achieves a predetermined desired resistive door torque that corresponds to a desired door velocity in response to an operator's manual operation. The operator can move the door at any desired velocity only having to overcome the predetermined desired resistive door torque allowing the door to feel as if the vehicle is on flat and level ground.

### CROSS-REFERENCE TO RELATED APPLICATIONS

This application claims priority to U.S. Provisional Application No. 62/255,229, which was filed on Nov. 13, 2015 and is incorporated herein by reference.

### BACKGROUND

This disclosure relates to the control of powered automobile side doors and specifically to a servomechanism that provides a unique assisted manual functional characteristic desirable to the operator.

Powered side doors are generally known in the automotive industry and prior art with automatic opening and closing being desirable features, facilitated by electric or electro-hydraulic devices. Numerous operating characteristics are offered including fully automatic opening and closing, autonomous opening as the operator approaches the vehicle and obstacle detection so that the door does not contact other cars, humans or stationary objects. The main disadvantage of these systems is that they do not provide an intuitive interaction when manual operation is desired.

Powered vehicle closures such as side doors, liftgates, trunk lids and sliding doors have become common automotive industry offerings and provide a convenience to the operator that allows ingress and egress flexibility as well as simplifying the loading of cargo. The majority of the available systems utilize an electric or electro-hydraulic power source that provides the required rotational torque between the door and vehicle body so as to automatically swing the door in a predetermined way. The simplest functionality is an automatic opening or closing through the full rotational range of motion. Additionally, obstruction detection methodologies are then required using capacitive, radar, electromagnetic or ultrasonic sensors to establish if there are proximate stationary or dynamic objects that may impinge on the door's motion envelope. These sensors can then be utilized to establish if an operator is approaching the vehicle and the system can then offer further functionality in autonomously opening the door in response. Additional features are generally enhancements of the method of initiating the automatic opening or closing of door such as occupant sensing for closure initiation.

The concept of a powered automotive side door was originally described in U.S. Pat. No. 1,151,479 to Kurtz, which discloses a power driven automatic door with which the driver could cause the door or doors to be opened or closed without the necessity of the driver leaving his seat. This function was achieved via an electric motor that was operated by simply closing a circuit switch. The required torque was imparted via worm gearing that was additionally configured to be disengaged if desired so as to provide normal manual operation. An electrically released latch or lock was also described. Kurtz provides the foundation for the basic operating characteristics of all power side doors that have been subsequently developed.

In more recent times DE19833612A1 to Bräuherr, et al. describes a powered door system in more detail than Kurtz, and with considerably more complexity, but no significant functional differentiation. Similarly US2006/0151231 describes an alternative power drive system that utilizes cables but achieves basically the same operating characteristic as Kurtz. However, this application introduces the concept of obstruction detection to assure that the door does not contact surrounding objects.

DE19927871C2 to Halbritter, discloses electronic control of the power drive unit and the ability to consider the vehicle attitude when driving the door in an automatic way.

Developments in power doors has more recently been focused in the area of the motion control of the door rather than the mechanical configuration of the drive.

DE102006019581 to Gensler et al. specifically claims the operating characteristics of a powered automobile side door in that a controller commands the power drive to provide different door velocities in response to operator inputs and surrounding conditions. Although the '581 patent describes numerous operating regimes, they are all predetermined velocity states that the power drive outputs with input, via a touch sensitive sensor system, from the operator. Gensler does not anticipate any type of intervention on manual door operation.

U.S. Pat. No. 9,159,219 B2 to Magner describes a control system for powered doors, specifically in relation to military vehicles, which uses multiple sensors to provide information to a controller to make operational decisions for the automatic operation of the door. Magner does not disclose any type of intervention on manual door operation.

The most significant practical problem associated with all of the prior art is that with the power drive coupled to the door, as is required for automatic usage, the manual operation becomes ergonomically unacceptable. The operator is required to push and pull against the power drive having to overcome the gearbox and electric motor, which requires back driving the device imparting significant torque around the door hinge axis. Alternately some form of decoupling can be provided, as disclosed in Kurtz over 100 years ago. This can be realized by the introduction of a clutch or neutral position in the gearbox but then the door is free to swing around its axis with no resistance or checking function when stopped. A mechanical checking device can then be introduced to provide an acceptably resistive ergonomic feel and holding force, but this then can only return the same functionality as a regular manual door system despite the considerable complexity and functionality provided by the power system.

### SUMMARY

In one exemplary embodiment, a power assisted automotive door system has a power drive module, which includes an electric motor and integrated gearbox drive unit configured to provide a driving torque around the door's pivot axis. A torque sensor is configured to measure torque imparted on the door, and a velocity sensor is configured to measure the speed of the door. A vehicle attitude sensor is configured to provide vehicle attitude, and an accelerometer is configured to provide feedback of a system dynamic state. A controller is in communication with the electric motor, the torque sensor, the velocity sensor, and the accelerometer. The controller is configured to process measured and provided data and to predict a door torque using a real-time simulation. The controller is configured to command the power drive module to produce a compensating torque that achieves a predetermined desired resistive door torque that corresponds to a desired door velocity in response to an operator's manual operation. The operator can move the door at any desired velocity only having to overcome the predetermined desired resistive door torque allowing the door to feel as if the vehicle is on flat and level ground.

In a further embodiment of the above, the real-time simulation includes a model based control system having closed loop, PID-based controls configured to cross check an open loop model simulation.

In a further embodiment of any of the above, the door velocity is provided by a motor position sensor.

In a further embodiment of any of the above, the controller includes a models of power drive module parameters including current, voltage, back electromotive force, inertia, friction, and/or backlash.

In a further embodiment of any of the above, the controller is configured to determine a component of the door torque attributable to at least one of vehicle attitude and wind.

In a further embodiment of any of the above, the electric motor and integrated gearbox drive unit imparts torque on the door via a direct spindle drive at the hinge axis.

In a further embodiment of any of the above, the electric motor and integrated gearbox drive unit imparts torque on the door via a drive arm and linkage.

In a further embodiment of any of the above, the electric motor and integrated gearbox drive unit imparts torque on the door via a lead screw and linkage.

In a further embodiment of any of the above, the electric motor and integrated gearbox drive unit imparts torque on the door via a worm gear and sector.

In another exemplary embodiment, a method of controlling a power-assisted automotive door with a power drive module includes applying a manual input to the door and predicting a door torque based upon the applied manual input and another door input. A compensating torque is determined and the compensating torque is applied to supplement the predicted door torque with the power drive module to achieve a predetermined desired resistive door torque corresponding to a desired door velocity.

In a further embodiment of any of the above, the manual input corresponds to a user pushing or pulling on the door.

In a further embodiment of any of the above, the applying step overrides an automatic door opening or closing.

In a further embodiment of any of the above, the other door input includes forces attributable to at least one of vehicle attitude and wind.

In a further embodiment of any of the above, the determining step includes evaluating door mass, door forces, and door inertia in a physics model of a door environment.

In a further embodiment of any of the above, the determining step includes detecting door acceleration and door hinge torque.

In a further embodiment of any of the above, the applying step includes commanding at least one of a brake assembly and a motor to achieve the predetermined desired resistive door torque.

In a further embodiment of any of the above, the door has a range of motion, and steps b)-d) are performed through the range of motion.

In a further embodiment of any of the above, the predetermined desired resistive door torque is constant through the range of motion.

### BRIEF DESCRIPTION OF THE DRAWINGS

The disclosure can be further understood by reference to the following detailed description when considered in connection with the accompanying drawings wherein:

FIG. 1 is a perspective view of one power drive module embodiment.

FIG. 2 is a schematic cross-sectional view of the power drive module taken along line 2-2 of FIG. 1 in a vehicle door control system.

FIG. 3 is a flow chart of the vehicle door control system used to provide a constant torque feel to a user in response to non-constant torque inputs on the door.

FIG. 4 is a schematic view of a power drive module embodiment with a direct spindle arrangement.

FIG. 5 is a perspective view of one power drive module embodiment with a lead screw arrangement.

FIG. 6 is a perspective view of one power drive module embodiment with a worm drive.

FIG. 7 is a graph illustrating a compensating torque provided by the power drive module to achieve a predetermined desired resistive torque.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

In view of the prior art power doors and their deficiencies, it is desirable to provide a powered automotive side door system that is capable of offering the myriad of automatic functions being demanded by the market, while also using the capabilities of the controller, electric motor and gearbox drive, providing an integrated gearbox drive unit, to deliver an assisted manual operation that is superior to the functionality of a purely manual door utilizing a conventional or infinite check device.

The problem associated with a conventional manual door system is that the force of operation, both running and checking, is developed as a torque around the hinge axis when the vehicle is oriented on a flat and level surface. The door check is capable of holding the door with the vehicle oriented at a variety of attitudes, such as nose up or nose down on a steep road, but the effort that the operator must impart to move the door is significantly affected by this orientation. With a vehicle parked in a steep uphill attitude the operator will struggle to open the door while in a downhill attitude they will have to hold the door back to prevent the door from running away. In a gusty wind with the vehicle in a non-level attitude the door can become almost impossible to control as the torque around the hinge axis becomes large and inconsistent and exceeds the capability of mechanical check mechanisms.

The disclosed vehicle door control system utilizes the power door controller, electric motor and gearbox drive in a servomechanical mode that allows a semi-manual operation in which the system returns a constant, ergonomically agreeable resistive force independent of vehicle attitude and other outside influences such as wind. The resistive torque is predetermined and can be constant or variable. In one disclosed embodiment, the resistive torque is set to be constant during manual operation independent of vehicle attitude or outside influences despite the non-linear geometry associated with the location of the door's center of gravity moving relative to the hinge axis during motion.

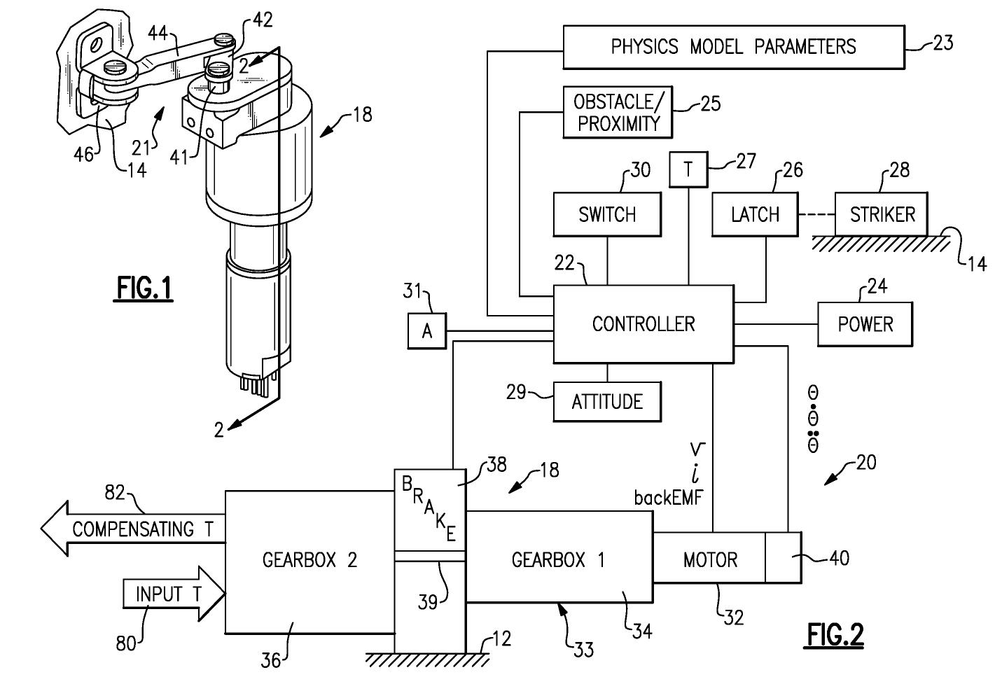

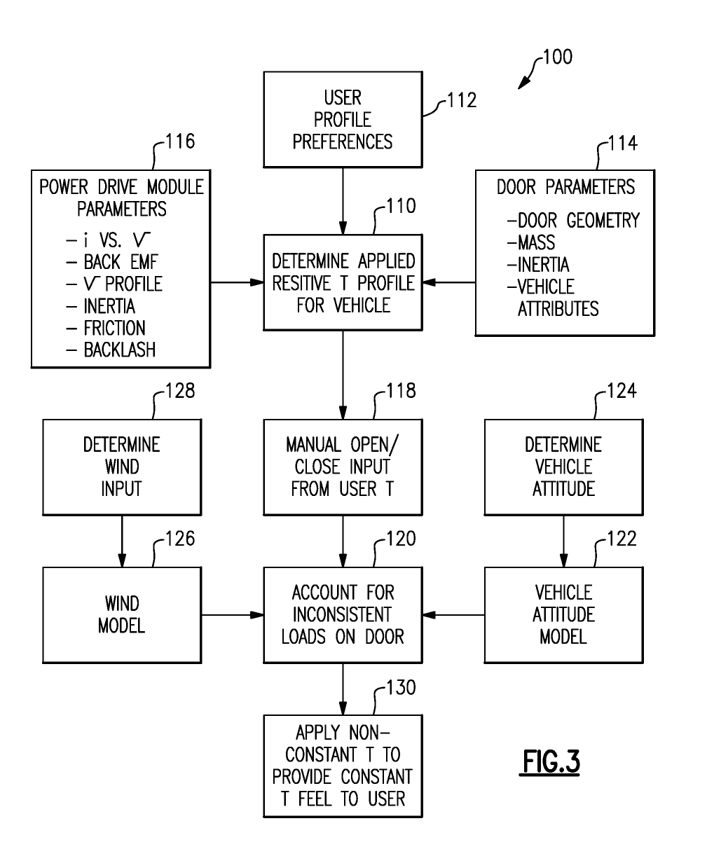

One example power drive module and vehicle door control system is shown in FIGS. 1 and 2. An example power drive module that may be used is disclosed in PCT Application No. PCT/US2015/025074, filed on 29 Apr. 2015, entitled “Vehicle Door System with Power Drive Module,” which is incorporated herein by reference in its entirety. In that arrangement, the power drive module 18 is arranged within a door and is secured to a door pillar 14 via a linkage 21, for example, and can be used to open and close the door as well as provide the resistive torque to hold the door in a desired open position. It should be understood, however, that other power drive module configurations can be used.

The employed methodology to achieve this independent constant torque operation is a model based controls strategy that utilizes a high fidelity mathematical representation of the physical system to provide the command signals to drive the power drive. A number of sensors in the door and vehicle body are utilized to measure data such as hinge axis torque, rotary displacement and velocity, vehicle attitude, power drive current, voltage and back electromotive force (EMF), obstruction detection and accelerometers. The sensors provide the system model with information so that states can be fully established and the model predicts the required motor torque to counter all imparted loads and return the predetermined operating torque. In this manner the operator can move the door at any desired velocity having only to overcome the desired predetermined resistive door torque. The door then ultimately feels as if the vehicle is on flat and level ground at all times during assisted manual servo controlled operation.

This control strategy is applicable to any style of drive arrangement including direct spindle, crank arm, worm drive or lead screw configurations (e.g., FIGS. 4-6). It relies on an electric motor and gearbox of high bandwidth control capability.

Referring to FIG. 2, the vehicle door control system includes a controller 22, or electronic control unit (ECU) having microprocessor based integrated power electronics, that receives inputs from various components as well as sends command signals to the power drive module 18 to open and close the door 12 in response to a user request. A power supply 24 is connected to the controller 22, which selectively provides electrical power to the power drive module 18 in the form of commands. A latch 26 and a switch 30 are also in communication with the controller 22. The latch 26, which is carried by the door, is selectively coupled and decoupled to a striker 28 mounted to the door pillar 14. The switch 30 provides a first input to the system 20 indicative of a user request to automatically open or close the door for automated operation of the door without the user manually pushing or pulling on the door.

The power door module 18 includes a motor 32 arranged within a housing 33, first and second gearboxes 34, 36, a shaft member 39 and a brake assembly 38 is positioned between the first and second gearboxes 34, 36 in the example shown. More or fewer gearboxes may be used, and the brake assembly may be positioned differently than shown. The brake assembly 38 is grounded to the door 12 via the housing 33 and is selectively connected to the shaft member 39. Referring to FIG. 1, the second gearbox 36 rotationally drives an output shaft 41 coupled to the linkage assembly 21. A lever 42 is mounted to the output shaft 41 at one end and to a strap 44 at the other end. The strap 44 is pinned to a bracket 46 fastened to the door pillar 14. The linkage assembly 21 is designed to provide a torque to the vehicle door that as is desired for any of the door opening and closing and holding operations.

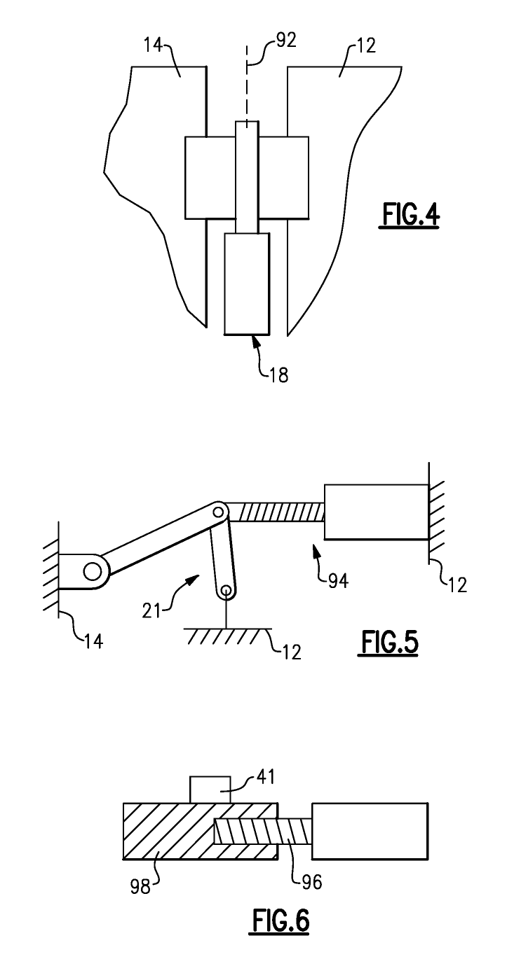

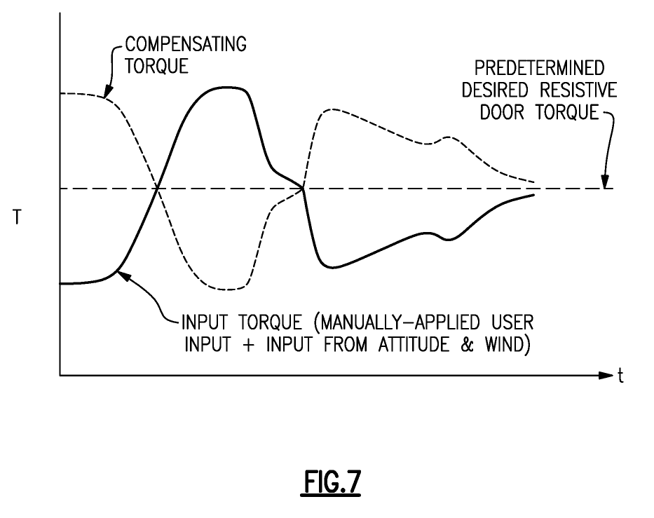

The motor 32 and integrated gearbox (or gearboxes) may impart torque on the door 12 using a variety of configurations other than the configuration described above. For example, in one example arrangement, the power drive module 18 imparts torque on the door 12 via a direct spindle drive 90 at the hinge axis 92, as shown schematically in FIG. 4. In another example shown in FIG. 5, torque is imparted on the door via a lead screw 94 and linkage 21. As shown in FIG. 6, a worm gear 96 and sector 98 arrangement may be used to impart torque on the door 12.

Returning to FIG. 2, the controller 22 includes physics model parameters 23, which includes a physics model of the door system. While feedback within the control system, the physics model parameters is a model of the physical environment of the door, including masses, forces, inertia and other vehicle-specific information.

The controller 22 is in communication with a hinge torque sensor 27 and a door mounted multi-axis accelerometer 31. The hinge torque sensor 27 can be integrated with the power drive module 18, if desired.

In one example, a proximity/obstruction sensor 25, such as an optical sensor, is in communication with the controller 22 and is used to generate a stop command if an obstruction is detected while the passenger is opening the door. The proximity/obstruction sensor 25 is mounted in the vehicle's door mirror base for example, or other sensor locations such as the door handle. The proximity/obstruction sensor 25 can be used to sense an obstruction or a user. It should be understood that any type of sensors may be used, such as optical, capacitive, radar, electromagnetic or ultrasonic sensors to establish if there are proximate stationary or dynamic objects near the door.

Undesired wind forces can be inferred using the physics model parameters. For example, the effects of the door mass, vehicle attitude, user profile preferences and other information is taken into account and backed out of the door acceleration and hinge torque detected. Any remaining force can be attributed to wind forces exerted on the door.

A vehicle attitude sensor 29 is in communication with the controller 22 and is used to detect the attitude of the vehicle, which is useful in controlling the motion of the door 12 when operated by the power drive module 18 and applying a supportive or resistive torque that accounts for the variable behavior of the door as it swings open or closed.

A position sensor 40, which is in communication with the controller 22, monitors the rotation of a component of the power drive module 18, for example, the motor 32. In one example, the position sensor 40 is an integrated Hall Effect sensor that detects the rotation of a shaft of the motor 32. The motor 32 and sensor 40 provide the controller with displacement (θ), velocity (\dot{θ}) and acceleration (\ddot{θ}), for example. Further sensors directly incorporated into the controller 22 provide it parameters such as voltage (v), current (i), back electromotive force (backEMF), for example, and thus allow it to monitor primary motor functions. The physics model parameters 23 stores and models these and other power drive module parameters relating the power drive module 18, such as friction, inertia, and backlash. Other information relating to the door can be stored in physics model parameters 23, such as door geometry, door mass and inertia and vehicle characteristics. User profile preferences relating to how much user opening/closing force the door will be responsive to, for example, can be stored in physics model parameters 23 as well.

Additional features of the described servomechanical, model based control system can include a predetermined holding or check torque when the rotary velocity reaches zero. This check torque can be infinite when there is no demanded motion so that there is no risk of a door closing on the occupant or opening onto an adjacent car or object. Once an operator demanded torque is sensed, the check torque can be softly ramped down to the predetermined resistive torque with any type of required characteristic degradation to achieve a quality feel. Gusting wind torque impingement is filtered within the model so that it is ignored and countered by the drive motor via the model based control system. Fling-open and fling-close velocities can be sensed and end of travel torque build-up can be provided so as to control the door at its extent with any type of required characteristic build-up to achieve a quality performance. If deemed necessary, the resistive torque can be made non-constant depending on door position, vehicle attitude or outside influences. The model based control is able to predict performance for any requirement and accurately demand the required power drive torque. The predetermined resistive torque can be made operator-adjustable so as to cater to different operator's physical capabilities.

The model based control contains a highly accurate mathematical representation of the physical door geometry, mass-inertial characteristics and the vehicle defined as datum. It also includes all of the sensor inputs as well as the relevant motor and gearbox operating characteristics such as current vs. torque, back electromotive force vs. imparted torque, voltage profiles, inertia, friction and backlash. Running at a high sensor and simulation calculation rate, preferably in excess of 1000 Hz, the model can predict the required motor drive power for all required states so as to return the demanded constant resistive door torque. In addition to the primary model-based control there are a number of smaller, additional closed loop, proportion-integral-derivative (PID) or error based sub-controls to assure that the system is safety compliant and stays within its state limits. The PID based controls cross check the fundamentally open loop model simulation. Safety functionality is therefore through redundant calculation of operation parameters and additional operating functionality can be provided by these closed loop sub-controls.

Referring to FIG. 3, a method 100 used by the controller 22 to operate a power drive module to drive a vehicle door in manual mode using a model based control system capable of accurately predicting the system performance using real time simulation is shown. The controller 22 determines a desired applied resistive torque profile Tₐₚₚᵣₑₛ for the particular vehicle (block 110).

Tₐₚₚᵣₑₛ=T_{pdu1}+Tᵣₑₛ−T_{pref} Equation 1.
Where: Tₐₚₚᵣₑₛ=applied resistive torque profile from power drive module
   T_{pdu1}=torque output from power drive unit
   Tᵣₑₛ=torque on door due to physical properties and mechanism
T_{pref}=desired torque profile

T_{pref}=D_{pref}*\dot{θ}+F_{det}+I_{pref}*\ddot{θ} Equation 2.
D_{pref}=desired resistance feel
θ, \dot{θ}, \ddot{θ}=door open angle, velocity and acceleration
F_{det}=desired detent feel {when −vₜ<\dot{θ}<vₜ}
vₜ=velocity threshold, below which door enters detent
I_{pref}=desired inertia feel

Tᵣₑₛ=Dᵣₑₛ*\dot{θ}+Iᵣₑₛ*\ddot{θ}+T_{grav1} Equation 3.
Dᵣₑₛ=friction in mechanism
Iᵣₑₛ=inertia of door
T_{grav1}=torque on door due to gravity on level ground

The desired applied torque profile is determined by using the user profile preferences (block 112) and the door parameters (block 114), examples of which are provided below.
D_{pref}=desired resistance feel
F_{det}=desired detent feel {when −vₜ<\dot{θ}<vₜ}
I_{pref}=desired inertia feel
Dᵣₑₛ=friction in mechanism
Iᵣₑₛ=inertia of door
h_{xy}=hinge inclination in the X/Z plane (pitch)
h_{yz}=hinge inclination in the Y/Z plane (roll)
M=mass of door

The desired applied torque profile may further be determined by using the power drive module (block 116) and parameters associated with the motor 32, for example.

$${T}_{motor} = zeta * P * Z * ϕ * \frac{{I}_{t}}{2 * π * A} . \qquad Equation 4$$

Where: Tₘₒₜₒᵣ=electromagnetic torque from motor
   zeta=efficiencies
   φ=magnetic flux per pole
   P=number of poles
   Iₜ=total current
   Z=number of conductors
   A=number of parallel paths

T_{pdu1}=Tₘₒₜₒᵣ−T_{fric}−T_{driv}−Iₘₒₜₒᵣ*\ddot{θ} Equation 5.
Where: T_{pdu1}=torque output from power drive unit
T_{fric}=function of \dot{θ}, friction and damping
T_{driv}=function of θ and backlash
Iₘₒₜₒᵣ=inertia of motor

The controller 22 identifies a manual door opening or closing input manually applied by the user or operator Tᵤₛₑᵣ (block 118), which may be provided by the user applying a force (pushing or pulling) to the door, window frame or other structure associated with the door.

In order to provide a constant resistive torque feel to the user, the controller 22 accounts for other door inputs that include inconsistent or undesired loads on the door (block 120)—other than the user applied force—which may originate from wind loads or the vehicle's attitude.

T_{pdu2}=Tₐₚₚᵣₑₛ−T_{wind}−T_{grav2}−Tᵤₛₑᵣ Equation 6.
Where: T_{pdu2}=total torque applied to door
   Tₐₚₚᵣₑₛ=applied resistive torque profile from power drive module
   T_{wind}=torque on door due to wind
   T_{grav}=torque on door due to gravity
   Tᵤₛₑᵣ=torque applied by the operator

To this end, these varying door torques are calculated using a vehicle attitude model (block 122) that relies on the vehicle's determined attitude (block 124).

T_{grav2}=func(h_{xz},i_{xz},h_{yz},i_{yz},M,R_{cg}) Equation 7.
Where: i_{xz}=vehicle inclination in the X/Z plane (pitch)
   i_{yz}=vehicle inclination in the Y/Z plane (roll)
   R_{cg}=door center of gravity
   T_{grav2}=torque on door due to vehicle inclination

$$\begin{matrix}{i}_{xz} = atan ( \frac{{A}_{x}}{{A}_{z}} ) . & Equation 8 \\ {i}_{yz} = atan ( \frac{{A}_{y}}{{A}_{z}} ) . & Equation 9\end{matrix}$$

Where: Aₓ, A_{y}, A_{z}=accelerometer components in X, Y, and Z directions

A wind model (block 126) may also be used that relies on determined parameters using wind inputs (block 128).

T_{wind}=func(Tₜₒₜₐₗ,G(z)) Equation 10.
Where: Tₜₒₜₐₗ=total applied torque, ie., sum of torque from operator and wind (80 in FIG. 1)
   G(z)=digital filter

Tₜₒₜₐₗ=Tᵣₑₛ−T_{grav2}−T_{pdu1} Equation 11.

These varying loads provide a varying input 80 (FIG. 2) on the door, corresponding to T_{wind} and T_{grav}, that would otherwise generate an undesirable variable resistive torque profile felt by the user when manually operating the door. Thus, a non-constant compensating torque T_{pdu2} (82 in FIG. 2; block 130) is applied to counter the variable torque from wind and attitude to create a constant predetermined desired resistive door torque feel to the user T_{pref}, for example. This relationship is graphically illustrated in FIG. 7 and expressed in Equation 6.

The non-constant torque can be generated using the rotational drive from the motor 32 and/or brake assembly 38 to provide the desired door velocity, which may be based upon a manual input provided by the operator. As a result, the operator can move the door at any desired velocity only having to overcome the predetermined resistive torque, allowing the door to feel as if the vehicle is on flat and level ground at all times (i.e., throughout the door's range of motion) during assisted manual servo controlled operation.

The disclosed vehicle door control system offers all of the automatic functionality of the prior art while also providing a highly desirable and intuitive semi-manual servo control mode in which the system allows the operator to manually move the door with a constant, ergonomically agreeable resistive force independent of vehicle attitude and other outside influences. This technology is equally applicable to other automotive powered closures such as liftgates, rear doors, sliding doors, tailgates, trunk lids and hoods.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the disclosed vehicle door control system. Moreover, although the different examples have specific components shown in the illustrations, embodiments of this system are not limited to those particular combinations. It is possible to use some of the components or features from one of the examples in combination with features or components from another one of the examples. Furthermore, although an example embodiment has been disclosed, a worker of ordinary skill in this art would recognize that certain modifications would come within the scope of the claims. For that reason, the following claims should be studied to determine their true scope and content.

What is claimed is:

1. A power assisted automotive door system comprising:
a power drive module including an electric motor and integrated gearbox drive unit configured to provide a driving torque around the door's pivot axis;
a torque sensor configured to measure torque imparted on the door;
a velocity sensor configured to measure the speed of the door;
a vehicle attitude sensor configured to provide vehicle attitude;
an accelerometer configured to provide feedback of a system dynamic state; and
a controller in communication with the electric motor, the torque sensor, the velocity sensor, and the accelerometer, the controller configured to process measured and provided data and to predict a door torque using a real-time simulation, the controller configured to command the power drive module to produce a compensating torque to achieve a predetermined desired resistive door torque corresponding to a desired door velocity in response to an operator's manual operation such that the operator can move the door at any desired velocity only having to overcome the predetermined desired resistive door torque, allowing the door to feel as if the vehicle is on flat and level ground.

2. The power assisted automotive door system of claim 1, wherein the real-time simulation includes a model based control system having closed loop, PID-based controls configured to cross check an open loop model simulation.

3. The power assisted automotive door system of claim 1, wherein the door velocity is provided by a motor position sensor.

4. The power assisted automotive door system of claim 1, wherein the controller includes a models of power drive module parameters including current, voltage, back electromotive force, inertia, friction, and/or backlash.

5. The power assisted automotive door system of claim 1, wherein the controller configured to determine a component of the door torque attributable to at least one of vehicle attitude and wind.

6. The power assisted automotive door system of claim 1, wherein the electric motor and integrated gearbox drive unit imparts torque on the door via a direct spindle drive at the hinge axis.

7. The power assisted automotive door system of claim 1, wherein the electric motor and integrated gearbox drive unit imparts torque on the door via a drive arm and linkage.

8. The power assisted automotive door system of claim 1, wherein the electric motor and integrated gearbox drive unit imparts torque on the door via a lead screw and linkage.

9. The power assisted automotive door system of claim 1, wherein the electric motor and integrated gearbox drive unit imparts torque on the door via a worm gear and sector.

10. A method of controlling a power-assisted automotive door with a power drive module, comprising:
a) applying a manual input to the door;
b) predicting a door torque based upon the applied manual input and another door input;
c) determining a compensating torque; and
d) applying the compensating torque to supplement the predicted door torque with the power drive module to achieve a predetermined desired resistive door torque corresponding to a desired door velocity.

11. The method of claim 10, wherein the manual input corresponds to a user pushing or pulling on the door.

12. The method of claim 11, wherein the applying step overrides an automatic door opening or closing.

13. The method of claim 10, wherein the other door input includes forces attributable to at least one of vehicle attitude and wind.

14. The method of claim 10, wherein the determining step includes evaluating door mass, door forces, and door inertia in a physics model of a door environment.

15. The method of claim 14, wherein the determining step includes detecting door acceleration and door hinge torque.

16. The method of claim 10, wherein the applying step includes commanding at least one of a brake assembly and a motor to achieve the predetermined desired resistive door torque.

17. The method of claim 10, wherein the door has a range of motion, and steps b)-d) are performed through the range of motion.

18. The method of claim 17, wherein the predetermined desired resistive door torque is constant through the range of motion.
